(19) United States
(12) Patent Application Publication
(10) Pub. No.: US 2003/0016599 A1
(43) Pub. Date: Jan. 23, 2003

(54) Optical disc apparatus

(76) Inventor: Takahiro Watanabe, Ehime (JP)

Correspondence Address: WENDEROTH, LIND & PONACK, L.L.P., 2033 K STREET N. W., SUITE 800, WASHINGTON, DC, 20006-1021, US

(21) Appl. No.: 10/195,482

(22) Filed: Jul. 16, 2002

(30) Foreign Application Priority Data
Jul. 17, 2001 (JP) 2001-217197

(51) Int. Cl. G11B 7/095

(52) U.S. Cl. 369/44.32; 369/53.14; 369/53.15

(57) ABSTRACT

The present invention provides an optical disc apparatus which is able to accurately correct eccentricity even when an optical disc slides in the rotating direction. A minimum value detection means 20 detects amplitude of a TE signal, a comparator 10 compares the amplitude with a reference value to detect sliding of the optical disc, and an eccentricity amount to be held in a storage means 5 is obtained by remeasurement when a flaw detection signal 22 is not outputted.

### FIELD OF THE INVENTION

The present invention relates to an optical disc apparatus which records/reproduces data, with correcting eccentricities of optical discs and optical disc drives.

### BACKGROUND OF THE INVENTION

Optical discs have certain amounts of eccentricity. When servo control is performed on this eccentric optical discs only by tracking control, a heavy burden is placed on the tracking control and, thus, there is a possibility that an adverse effect is exerted on recording/reproduction signals, or tracking deviation is generated as tracking capability is exceeded.

Conventionally, as an optical disc apparatus which corrects eccentricity, one disclosed in Japanese Published Patent Application No. Sho.63-271734 is known.

FIG. 11 is a block diagram illustrating the construction of this conventional optical disc apparatus.

In FIG. 11, the optical disc apparatus comprises an optical head 2, a transfer means 3, an amplification means 4 for amplifying a control signal and a reproduction signal such as data, a storage means 5, a control amplification circuit 6, a reading means 8 for detecting a signal of a track address, a sector address or the like, which corresponds to one rotation of an optical disc 1, an addition means 9, a comparator 10 for judging whether a total deviation amount outputted from the addition means 9 exceeds a setting level 11 or not, and a spindle motor 21, thereby recording or reproducing data on/from the optical disc 1.

Next, the operation of the so-constructed conventional optical disc apparatus will be described.

Initially, an optical beam emitted from the optical head 2 is reflected at the optical disc 1, and thereafter the reflected optical beam is received by the optical head 2 and inputted to the amplification means 4. Then, after the amplification means 4 detects a tracking error signal (hereinafter, referred to as a TE signal), the amplification means 4 passes the TE signal through a low pass filter and extracts a low-frequency component of the TE signal that corresponds to an eccentricity amount of the optical disc 1. A low-frequency component in an amount corresponding to one rotation of the optical disc 1 is stored in the storage means 5 as the eccentricity amount. Then, the eccentricity amount is read from the storage means 5 according to a rotational position of the optical disc 1, and the eccentricity amount is applied to the control amplification circuit 6 and inputted to the transfer means 3, to control the transfer means 3 so that it is driven in the direction in which the eccentricity amount is suppressed.

When a signal applied to the transfer means 3 and an actual eccentricity amount are out of phase due to sliding of the optical disc 1 in the rotating direction, the optical disc apparatus obtains an amount of deviation between address information or the like, which is read from the optical disc 1, and a reference signal, integrates the deviation amount by the addition means 9, and compares the integration result with the setting level 11 by the comparator 10. When the integration result exceeds the setting level 11, the eccentricity amount is remeasured and the remeasured eccentricity amount is stored in the storage means 5, thereby responding to the sliding of the optical disc 1.

The conventional optical disc apparatus employs the address information or the like, which is read from the optical disc, to detect the sliding of the optical disc in the rotating direction. However, when tracking control is affected by the eccentricity correction that is performed since the sliding occurs, a rate of reading the address information or the like is reduced, and a precise timing of detecting the sliding cannot be obtained.

Further, since the address information can be only employed after tracking servo works and data is correctly read, it cannot be confirmed whether deviation is generated between the stored eccentricity amount and an actual disc eccentricity amount, in a state where the data cannot be correctly read, for example, immediately after seeking is performed.

Therefore, it is required to correct eccentricity as well as correct eccentricity after remeasurement by employing a method of detecting optical disc sliding that is not based on information recorded on the optical disc, such as the address information.

### SUMMARY OF THE INVENTION

The present invention is made to solve the above-mentioned problems and has for its object to provide an optical disc apparatus which detects sliding of an optical disc on the basis of information such as a tracking error signal, and remeasures an eccentricity amount to correct eccentricity.

Other objects and advantages of the present invention will become apparent from the detailed description that follows. The detailed description and specific embodiments described are provided only for illustration since various additions and modifications within the scope of the invention will be apparent to those of skill in the art from the detailed description.

According to a first aspect of the present invention, there is provided an optical disc apparatus for recording or reproducing data on/from an optical disc by applying an optical spot on the optical disc with an optical pickup, comprising: an error signal generation means for generating an error signal for making the optical pickup follow a track on the optical disc; an eccentricity amount detection means for detecting an eccentricity amount of the optical disc; a storage means for storing the eccentricity amount detected by the eccentricity amount detection means; and a control means for performing control so as to correct the eccentricity amount stored in the storage means when the output from the error signal generation means has a value larger than a prescribed setting value. Therefore, it is possible to detect sliding of the optical disc in the rotating direction, which is caused by an effect of imperfect attachment of the optical disc, dust or the like, when a rotating rate of a spindle motor is changed or the like, by employing a tracking error signal, and correct eccentricity without reading an address or data on the optical disc. Thereby, an abnormal state of tracking control at execution of the eccentricity correction can be prevented.

According to a second aspect of the present invention, there is provided an optical disc apparatus for recording or reproducing data on/from an optical disc by applying an optical spot on the optical disc with an optical pickup, comprising: an error signal generation means for generating an error signal for making the optical pickup follow a track on the optical disc; an eccentricity amount detection means for detecting an eccentricity amount of the optical disc; a storage means for storing the eccentricity amount detected by the eccentricity amount detection means; a comparison circuit for comparing the eccentricity amount outputted from the storage means with a prescribed reference value; and a control means for performing control so as to correct the eccentricity amount stored in the storage means when the comparison circuit detects that the eccentricity amount exceeds the prescribed reference value. Therefore, it is possible to discriminate between an effect due to sliding of the optical disc in the rotating direction and an effect due to flaws, thereby suppressing the effect due to flaws and reducing the rate of remeasuring eccentricity amount.

According to a third aspect of the present invention, there is provided an optical disc apparatus for recording or reproducing data on/from an optical disc by applying an optical spot on the optical disc with an optical pickup, comprising: an error signal generation means for generating an error signal for making the optical pickup follow a track on the optical disc; an eccentricity amount detection means for detecting an eccentricity amount of the optical disc; a storage means for storing the eccentricity amount detected by the eccentricity amount detection means; a phase difference detection means for detecting a phase difference between the eccentricity amount outputted from the eccentricity amount detection means and the eccentricity amount outputted from the storage means; and a control means for performing control so as to correct the eccentricity amount stored in the storage means when the output from the phase difference detection means has a value larger than a prescribed setting value. Therefore, when sliding of the optical disc in the rotating direction is detected, eccentricity correction is suspended and a phase difference between a newly measured eccentricity amount and an already measured eccentricity correction amount is detected, whereby sliding of the optical disc can be detected more accurately.

According to a fourth aspect of the present invention, there is provided an optical disc apparatus for recording or reproducing data on/from an optical disc by applying an optical spot on the optical disc with an optical pickup, comprising: an error signal generation means for generating an error signal for making the optical pickup follow a track on the optical disc; a rotational position detection means for outputting a signal according to a rotational position of a rotation means that rotates the optical disc; an eccentricity amount detection means for detecting an eccentricity amount of the optical disc; a storage means for storing the eccentricity amount detected by the eccentricity amount detection means; a phase difference detection means for detecting a phase difference between position information outputted from the rotational position detection means and the eccentricity amount outputted from the storage means; and a control means for performing control so as to correct the eccentricity stored in the storage means when the output from the phase difference detection means has a value larger than a prescribed setting value. Therefore, when sliding of the optical disc in the rotating direction is detected, a phase difference between an actual eccentricity amount and an eccentricity correction amount can be detected without suspending eccentricity correction, by employing an FG signal as a reference signal at the phase comparison. Further, the eccentricity amount can be corrected without stopping the eccentricity correction.

According to a fifth aspect of the present invention, in the optical disc apparatus of the third or fourth aspect, the control means performs control so as to change a timing at which the storage means outputs an eccentricity correction amount, on the basis of the phase difference detected by the phase difference detection means when the output from the phase difference detection means has a value larger than the prescribed setting value. Therefore, the relation between eccentricity of the optical disc which is generated due to sliding of the optical disc and eccentricity correction can be restored to a state before the sliding of the optical disc occurs.

According to a sixth aspect of the present invention, in the optical disc apparatus of the third or fourth aspect, the control means performs control so that the storage means re-stores an eccentricity amount of the optical disc when the output from the phase difference detection means has a value larger than the prescribed setting value. Therefore, eccentricity of the optical disc can be corrected independently of information such as an address or data read from the optical disc.

According to a seventh aspect of the present invention, in the optical disc apparatus of any of the second to fourth aspects, the control means performs control so as to correct the eccentricity amount stored in the storage means only when the output from the error signal generation means has a value larger than the prescribed setting value. Therefore, sliding of the optical disc in the rotating direction can be more accurately detected.

According to an eighth aspect of the present invention, the optical disc apparatus of any of the first to fourth aspects further includes: a minimum value detection means for detecting that the minimum value of the output from the error signal generation means exceeds a prescribed value for more than a predetermined period of time, and in this optical disc apparatus the control means performs control so as to correct the eccentricity amount stored in the storage means only when the minimum value detection means detects that the minimum value of the output from the error signal generation means exceeds the prescribed value for more than the predetermined period of time. Therefore, sliding of the optical disc in the rotating direction can be more accurately detected.

According to a ninth aspect of the present invention, the optical disc apparatus of any of the first to fourth aspects further includes: a flaw detection circuit for detecting flaws on the optical disc, and in this optical disc apparatus the control means performs control so as not to correct the eccentricity amount stored in the storage means when the flaw detection circuit detects flaws. Therefore, it is possible to discriminate between an effect due to sliding of the optical disc in the rotating direction and an effect due to flaws, thereby suppressing unnecessary remeasurement of eccentricity amount.

### BRIEF DESCRIPTION OF THE DRAWINGS

FIG. 1 is a block diagram illustrating the construction of an optical disc apparatus according to a first embodiment of the present invention.

FIG. 2 is a timing chart for explaining the operation of the optical disc apparatus according to the first embodiment of the invention.

FIG. 3 is a block diagram illustrating the construction of an optical disc apparatus according to a second embodiment of the present invention.

FIG. 4 is a timing chart for explaining the operation of the optical disc apparatus according to the second embodiment of the invention.

FIG. 5 is a block diagram illustrating the construction of an optical disc apparatus according to a third embodiment of the present invention.

FIG. 6 is a timing chart for explaining the operations of the optical disc apparatuss according to the third and fourth embodiments of the present invention.

FIG. 7 is a block diagram illustrating the construction of the optical disc apparatus according to the fourth embodiment of the invention.

FIG. 8 is a block diagram illustrating the construction of an optical disc apparatus according to a fifth embodiment of the present invention.

FIG. 9 is a timing chart for explaining the operations of the optical disc apparatuss according to the fifth and sixth embodiments of the present invention.

FIG. 10 is a block diagram illustrating the construction of the optical disc apparatus according to the sixth embodiment of the invention.

FIG. 11 is a block diagram illustrating the construction of a conventional optical disc apparatus.

### DETAILED DESCRIPTION OF THE PREFERRED EMBODIMENTS

(Embodiment 1)

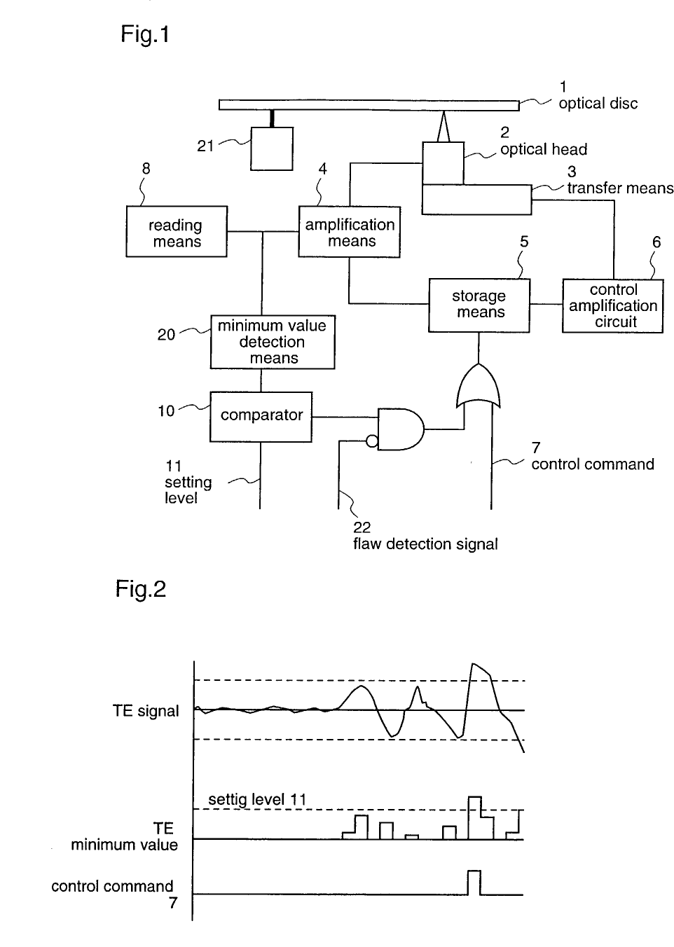

Hereinafter, a first embodiment of the present invention will be described with reference to FIGS. 1 and 2.

FIG. 1 is a block diagram illustrating the construction of an optical disc apparatus according to the first embodiment of the present invention.

In FIG. 1, the optical disc apparatus comprises an optical head 2, a transfer means 3, an amplification means (error signal generation means) 4 for amplifying a control signal and a reproduction signal such as data, a storage means 5, a control amplification circuit 6, a reading means 8 for detecting a signal of a track address, a sector address or the like, which corresponds to one rotation of an optical disc 1, a minimum value detection means 20 for detecting that the minimum value of a TE signal exceeds a setting value for more than a predetermined period of time, a comparator 10 for judging whether the output from the minimum value detection means 20 exceeds a setting level 11 or not, and a spindle motor 21, thereby recording or reproducing data on/from the optical disc 1.

Next, the operation of the so-constructed optical disc apparatus according to the first embodiment will be described.

In the optical disc apparatus, initially, the spindle motor 21 rotates the optical disc 1, and thereafter a laser beam is applied from the optical head 2 on the optical disc 1, and a focus serve control system, which is not shown, performs focus control on the basis of a reflected light from the optical disc 1 so that a distance between the optical head 2 and the disc surface is constant. After the focus control is started, tracking control is performed on the basis of the reflected light from the optical disc 1 as the focus control, so as to make the optical head 2 follow a track on the optical disc 1. The tracking control is performed by generating a TE signal by the amplification means 4 from a detected signal obtained by the optical head 2 and controlling the position of the optical head 2 on the basis of the TE signal. The amplification means 4 outputs the detected TE signal to the reading means 8 and the minimum value detection means 20.

After the tracking control is started, the optical disc apparatus performs eccentricity correction. Hereinafter, the operation for the eccentricity correction will be described in the order of measurement of eccentricity amount, execution of eccentricity correction on the basis of a measurement value, detection of sliding of the optical disc in the rotating direction, remeasurement of eccentricity amount, and restart of the eccentricity correction after the remeasurement.

Initially, an eccentricity amount is measured once as preparation for performing eccentricity correction. The first measurement of eccentricity amount is performed by extracting a low-frequency component of the TE signal with the amplification means 4, to obtain deviation corresponding to the eccentricity amount, in a state where the spindle motor 21 is rotated at a predetermined rate. The amplification means 4 outputs the detected eccentricity amount to the storage means 5.

The eccentricity amount that is detected by the amplification means 4 and inputted to the storage means 5 is stored in the storage means 5 for each period of time that is obtained by dividing time required for one rotation of the spindle motor 21 into N equal periods, on the basis of a control command 7 outputted from a control means not shown. Since the time required for one rotation of the spindle motor 21 is known by rotating it at a predetermined rate, this capture of eccentricity amount into the storage means 5 is performed for each period of time that is obtained by dividing the time required for one rotation into N equal periods, on the basis of a reference clock.

Next, eccentricity correction is performed. After the eccentricity amount is measured, the transfer means 3 is driven in the direction in which the eccentricity component is removed, to suppress an effect of the eccentricity component on the optical head 2, on the basis of the eccentricity component stored in the storage means 5, thereby performing the eccentricity correction. Reading of the eccentricity amount from the storage means 5 is performed for each period of time that is obtained by dividing the time required for one rotation of the spindle motor 21 into N equal periods, as the measurement of the eccentricity amount, on the basis of the same reference clock as that employed at the measurement.

Detection of sliding of the optical disc 1 in the rotating direction is performed while the eccentricity correction is executed. Initially, the minimum value detection means 20 receives the TE signal outputted from the amplification means 4, and detects whether the minimum value of the TE signal continues for more than a predetermined period of time or not. That is, the minimum value detection means 20 detects the minimum value of the TE signal in the predetermined period of time. The detected minimum value is outputted to the comparator 10. The comparator 10 compares this detected minimum value with the predetermined setting level 11, and judges that the eccentricity correction is not accurately performed due to sliding of the optical disc 1 in the rotating direction when the detected minimum value is larger than the setting level 11. Then, on the basis of this judgement, the comparator 10 outputs the control command 7 on re-storing in the storage means 5 through the control means not shown.

Remeasurement of eccentricity amount after the detection of sliding of the optical disc 1 is performed on the basis of the control command 7 outputted from the not-shown control means when the sliding of the optical disc 1 is detected. Then, the storage means 5 stores eccentricity amount which is remeasured according to the control command 7. When the remeasurement of eccentricity amount is performed, drive of the transfer means 3, which is performed on the basis of the eccentricity amount stored in the storage means 5, is suspended for fear that an actual eccentricity amount cannot be detected by performing the eccentricity correction.

A procedure for re-storing the eccentricity amount for one rotation of the optical disc 1 in the storage means 5 is the same as that at spinup. After the new eccentricity amount is stored in the storage means 5, drive of the transfer means 3 is restarted on the basis of the new eccentricity amount stored in the storage means 5.

In the optical disc apparatus, when the TE signal becomes higher due to flaws on the optical disc 1, such as finger printings or scratches, a flaw detection circuit not shown detects these flaws and outputs a flaw detection signal 22. Therefore, when the flaw detection circuit outputs the flaw detection signal 22, disturbance of the TE signal is judged to be due to flaws, and masking is performed so that the control command 7 on re-storing is not outputted to the storage means 5, thereby suppressing unnecessary re-storing in the storage means 5.

FIG. 2 is a timing chart illustrating a timing at which the optical disc apparatus according to the first embodiment remeasures the eccentricity amount.

FIG. 2 shows an example where the optical disc apparatus detects the minimum value of the TE signal for each predetermined period of time, and outputs the control command 7 on re-storing to perform remeasurement when the minimum value exceeds the setting level 11.

As described above, the optical disc apparatus according to the first embodiment detects sliding of the optical disc employing the minimum value detection means for detecting the minimum value of the tracking error signal, thereby detecting sliding of the optical disc independently of read address information. That is, eccentricity correction can be performed without reading an address or data on the optical disc, thereby preventing an abnormal state of tracking control at the execution of eccentricity correction. Further, since the flaw detection circuit is introduced, it is possible to discriminate between an effect due to sliding of the optical disc in the rotating direction and an effect due to flaws, thereby suppressing unnecessary remeasurement of eccentricity amount.

Further, the measurement of eccentricity amount may be also performed before tracking control is started after start of focus control, or after the tracking control is started, by measuring the number of tracks passing for each section of the optical disc while the optical disc rotates once, in a state where the tracking control is suspended once so that tracking servo is canceled, after the optical head 2 is moved to a target track.

(Embodiment 2)

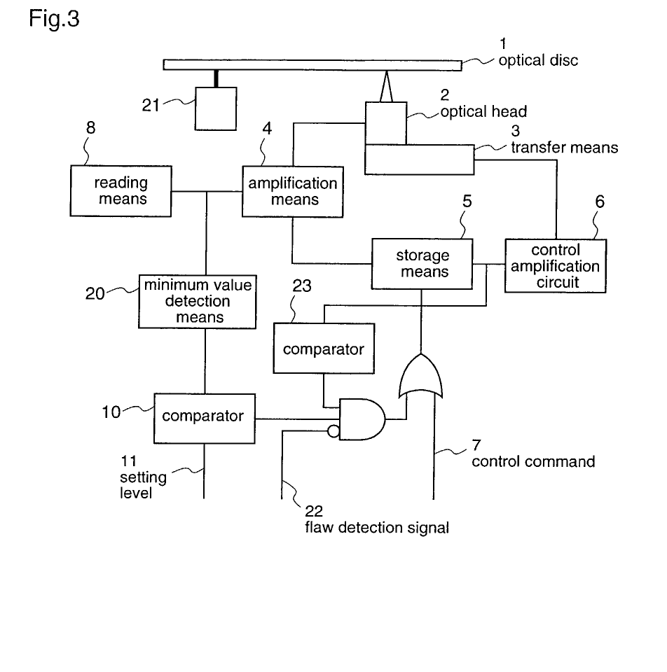

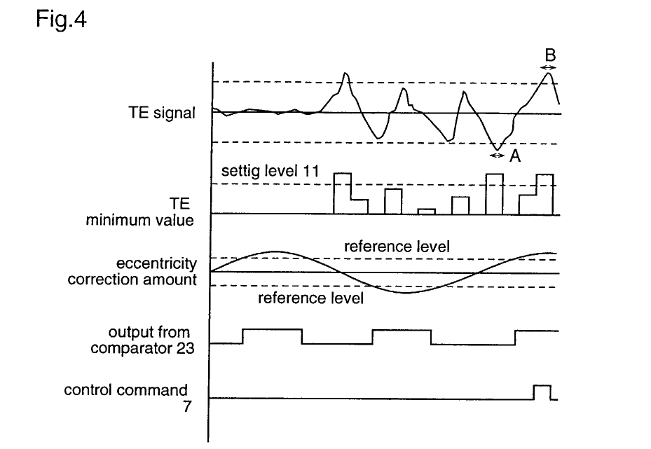

Hereinafter, a second embodiment of the present invention will be described with reference to FIGS. 3 and 4.

FIG. 3 is a block diagram illustrating the construction of an optical disc apparatus according to the second embodiment.

As shown in FIG. 3, the optical disc apparatus is provided with a comparator 23 for comparing a value of eccentricity correction information outputted from a storage means 5 with a reference value. Since the construction of the optical disc apparatus according to the second embodiment is identical to that of the optical disc apparatus according to the first embodiment except that the comparator 23 is provided, descriptions of other constituents will be omitted.

Next, the operation of the so-constructed optical disc apparatus according to the second embodiment will be described.

The operation until focus control and tracking control are performed after the spindle motor 21 rotates is performed in the similar procedure to that described for the first embodiment.

Eccentricity correction is performed after the tracking control is started. Hereinafter, the operation for the eccentricity correction will be described in the order of measurement of eccentricity amount, execution of eccentricity correction on the basis of a measurement value, detection of sliding of the optical disc 1 in the rotating direction, remeasurement of eccentricity amount, and restart of the eccentricity correction after the remeasurement.

Procedures for the first measurement of eccentricity amount and the execution of eccentricity correction are identical to those described for the first embodiment, and thus their descriptions will be omitted here.

Detection of sliding of the optical disc 1 in the rotating direction is performed as follows. Initially, the minimum value detection means 20 detects the minimum value of a TE signal which is detected by the amplification means 4. Then, the comparator 10 compares the minimum value with the setting level 11, and judges that the optical disc 1 might have slid when the minimum value exceeds the setting level 11.

Next, the comparator 23 receives an eccentricity correction amount which is outputted from the storage means 5 to the control amplification circuit 6, compares the eccentricity correction amount with a reference value, and judges that it is highly likely that the optical disc 1 has actually slid when the received eccentricity correction amount is larger than the reference value.

When the eccentricity correction amount inputted to the comparator 23 is larger than the reference value, and the minimum value of the TE signal outputted from the minimum value detection means 20 is larger than the setting level 11, it is judged that the eccentricity correction is not accurately performed due to sliding of the optical disc 1.

Further, when the minimum value of the TE signal is larger than the setting level 11 in a section where the eccentricity correction amount inputted to the comparator 23 is smaller than the reference value, that is, the eccentricity correction amount is small, it is judged that the TE signal becomes higher due to a factor other than sliding of the optical disc 1. In this case, for example, it is judged that a gain of a servo is insufficient, and other responses such as increasing the gain of the tracking servo are taken, and therefore sliding of the optical disc 1 is not detected.

Remeasurement of eccentricity amount after sliding of the optical disc 1 is detected is performed on the basis of the control command 7 concerning re-storing of eccentricity amount, which is outputted from the control means (not shown) on the basis of the above-described judgement. Then, the storage means 5 stores a remeasured eccentricity amount according to the control command 7.

When the remeasurement of eccentricity amount is performed, drive of the transfer means 3 that is performed on the basis of the eccentricity amount stored in the storage means 5, is suspended for fear that an actual eccentricity amount cannot be detected by performing eccentricity correction. A procedure for re-storing the eccentricity amount for one rotation of the optical disc 1 in the storage means 5 is the same as that at spin-up. After the new eccentricity amount is stored in the storage means 5, drive of the transfer means 3 is restarted on the basis of the eccentricity amount stored in the storage means 5.

In the optical disc apparatus, when the TE signal becomes higher due to flaws on the optical disc 1 or the like, a flaw detection circuit not shown detects these flaws and outputs a flaw detection signal 22. Therefore, when the flaw detection circuit outputs the flaw detection signal 22, disturbance of the TE signal is judged to be due to flaws, and masking is performed so that the control command 7 on re-storing is not outputted to the storage means 5 even when the above-described condition is satisfied, thereby suppressing unnecessary re-storing in the storage means 5.

FIG. 4 is a timing chart illustrating a timing at which the optical disc apparatus according to the second embodiment remeasures eccentricity amount.

Intervals A and B in FIG. 4 show cases where the minimum value of the TE signal detected by the amplification means 4 exceeds the setting level 11. The interval A shows an example where the remeasurement of eccentricity amount is not performed since the eccentricity correction amount which is subjected to comparison by the comparator 23 is smaller than the reference value. On the other hand, the interval B shows an example where it is judged that the sliding of the optical disc 1 is detected and the remeasurement of eccentricity amount is performed since the eccentricity correction amount which is subjected to comparison by the comparator 23 is larger than the reference value.

As described above, the optical disc apparatus according to the second embodiment is provided with the minimum value detection means and the comparison circuit for comparing the eccentricity correction amount outputted from the storage means with the reference value. Therefore, in addition to the effects achieved by the optical disc apparatus according to the first embodiment, it is possible to discriminate between an effect due to sliding of the optical disc in the rotating direction and an effect due to flaws or other factors, thereby accurately correcting an eccentricity amount without reading information of an address or data on the optical disc.

(Embodiment 3)

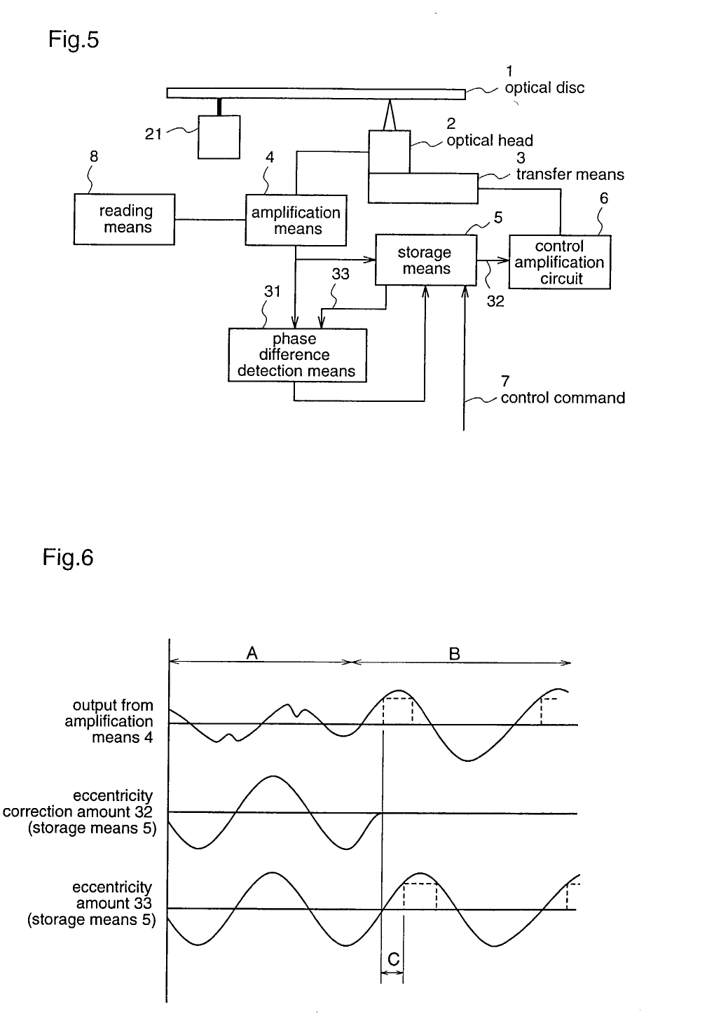

Hereinafter, a third embodiment of the present invention will be described with reference to FIG. 5.

FIG. 5 is a block diagram illustrating the construction of the optical disc apparatus according to the third embodiment.

As shown in FIG. 5, the optical disc apparatus is provided with a phase difference detection means 31 for detecting a phase difference between an eccentricity amount detected by an eccentricity amount detection means (amplification means 4) and an eccentricity amount 33 stored in a storage means 5. Since the construction of the optical disc apparatus according to the third embodiment is identical to that of the optical disc apparatus according to the first embodiment except that the phase difference detection means 31 is provided, descriptions of other constituents will be omitted.

Next, the operation of the so-constructed optical disc apparatus according to the third embodiment will be described.

The operation until focus control and tracking control are performed after the spindle motor 21 rotates is identical to that described for the first embodiment.

Eccentricity correction is performed after the tracking control is started. Hereinafter, the operation for the eccentricity correction will be described in the order of measurement of eccentricity amount, execution of eccentricity correction on the basis of a measurement value, detection of sliding of the optical disc 1 in the rotating direction, correction of the eccentricity amount, and restart of the eccentricity correction.

Procedures for the first measurement of eccentricity amount and the execution of eccentricity correction are identical to those described for the first embodiment.

Detection of sliding of the optical disc 1 in the rotating direction is performed as follows. Initially, control is performed so that output of an eccentricity correction amount 32 from the storage means 5 is suspended in a predetermined cycle or at random time intervals. Then, the phase difference detection means 31 makes a phase comparison between the eccentricity amount 33 outputted from the storage means 5 and the eccentricity amount outputted from the amplification means 4, in a state where the output of the eccentricity correction amount 32 from the storage means 5 is suspended. When a phase difference larger than a reference value is detected as the result of the phase comparison, it is judged that sliding of the optical disc 1 occurs.

While not shown, this optical disc apparatus may be also constructed to suspend the output of the eccentricity correction amount 32 from the storage means 5 when an error rate of data read from the optical disc 1 is detected as deteriorated.

Correction of eccentricity amount is performed as follows. Initially, the phase difference detection means 31 outputs the phase difference between the two signals to the storage means 5. Then, the storage means 5 changes the timing of outputting the eccentricity correction amount 32 so that the phase difference is removed, thereby modifying the eccentricity correction amount. That is, when the phase difference is large, i.e., when the phase is delayed, the timing of outputting the eccentricity correction amount 32 is made quicker so that the phase difference is reduced. On the other hand, when the phase difference is small, the timing of outputting the eccentricity correction amount 32 is delayed on the contrary. Thereafter, the suspended eccentricity correction is restarted. In this way, by changing the timing of outputting the eccentricity correction amount 32, the relation between eccentricity of the optical disc 1, which is generated due to sliding of the optical disc 1 and eccentricity correction can be restored to a state before the sliding of the optical disc 1 occurs.

FIG. 6 is a timing chart illustrating the timing at which the optical disc apparatus according to the third embodiment remeasures an eccentricity amount.

In FIG. 6, interval A indicates an interval in which eccentricity correction is performed on the basis of the eccentricity amount read from the storage means 5. In these intervals, the output from the amplification means 4 is the result of synthesis of the result of eccentricity correction performed on the basis of the eccentricity correction amount outputted from the storage means 5, and the amount of eccentricity of the optical disc itself which is generated due to deviation of the optical disc 1. The interval B in FIG. 6 indicates a specific period during which the eccentricity correction is suspended. In this period during which the eccentricity correction is suspended, information on actual eccentricity is outputted from the amplification means 4 (amplification means 4 in FIG. 6). The phase difference detection means 31 receives the eccentricity information outputted from the amplification means 4 and the eccentricity amount 33 outputted from the storage means 5 at the same timing as in the interval A, and measures a phase difference C between these two signals. The storage means 5 receives the phase difference C outputted from the phase difference detection means 31, and changes the timing of outputting the eccentricity correction amount 32 by the time for the phase difference C, and the eccentricity correction is restarted. At this time, the timing of outputting the eccentricity amount 33 is also changed by the same period of time.

As described above, the optical disc apparatus according to the third embodiment is provided with the phase difference detection means for detecting a phase difference between an actual eccentricity amount detected by the eccentricity amount detection means and an eccentricity amount stored in the storage means, thereby detecting sliding of the optical disc. Therefore, the timing of outputting the eccentricity correction amount from the storage means can be changed on the basis of the phase difference, whereby eccentricity of the optical disc can be corrected independently of information of an address or data read from the optical disc, and performing remeasurement of eccentricity amount.

In the above-mentioned description, eccentricity of the optical disc is corrected by changing the timing of outputting the eccentricity correction amount from the storage means 5 on the basis of the phase difference detected by the phase difference detection means 31. However, it is also possible that sliding of the optical disc 1 is judged to be generated when the phase difference detected by the phase difference detection means 31 is larger than the reference value, a control means (not shown) outputs the control command 7 to the storage means 5, and the storage means 5 re-stores an eccentricity amount according to the control command, whereby eccentricity of the optical disc 1 can be similarly corrected independently of the information of an address, data, or the like which is read from the optical disc 1.

(Embodiment 4)

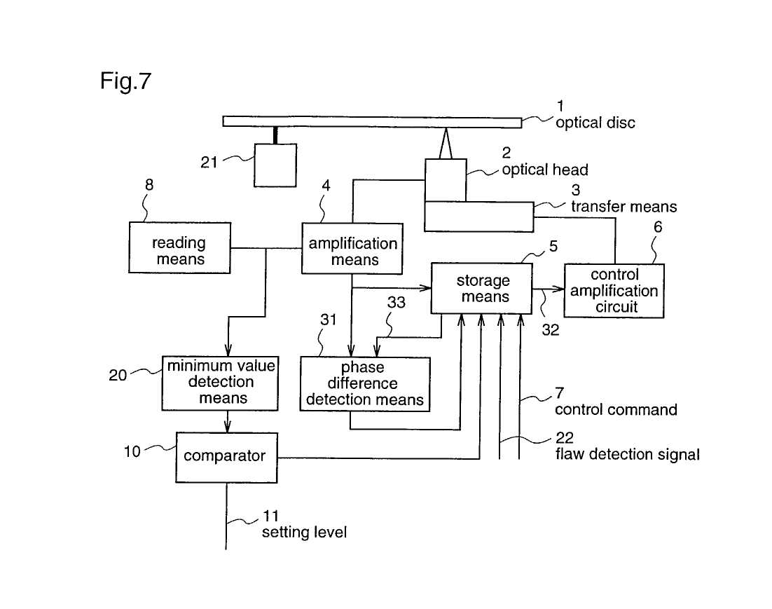

Hereinafter, a fourth embodiment of the present invention will be described with reference to FIGS. 7 and 6.

FIG. 7 is a block diagram illustrating the construction of an optical disc apparatus according to the fourth embodiment.

In FIG. 7, respective constituents of the optical disc apparatus according to the fourth embodiment are already described for the first and third embodiments, and thus repeated description is not necessary.

Next, the operation of the so-constructed optical disc apparatus according to the fourth embodiment will be described.

The operation until focus control and tracking control are performed after the spindle motor 21 rotates is identical to that described for the first embodiment.

Eccentricity correction is performed after the tracking control is started. Hereinafter, the operation for the eccentricity correction will be described in the order of measurement of eccentricity amount, execution of eccentricity correction on the basis of a measurement value, detection of sliding of the optical disc 1 in the rotating direction, correction of the eccentricity amount, and restart of the eccentricity correction.

Procedures for the first measurement of eccentricity amount and the execution of eccentricity correction are identical to those described for the first embodiment.

Detection of sliding of the optical disc 1 is performed as follows. Initially, the minimum value detection means 20 detects the minimum value of a TE signal which is detected by the amplification means 4. Then, the comparator 10 compares the minimum value with the setting level 11. When the minimum value exceeds the setting level 11, control is performed so that output of the eccentricity correction amount 32 from the storage means 5 is suspended. Next, the phase difference detection means 31 makes a phase comparison between the eccentricity amount 33 outputted from the storage means 5 and the eccentricity amount outputted from the amplification means 4, in a state where the output of the eccentricity correction amount from the storage means 5 is suspended. When a phase difference larger than a reference value is detected as the result of the phase comparison, it is judged that sliding of the optical disc 1 occurs.

Correction of eccentricity amount is performed as follows. Initially, the phase difference detection means 31 outputs the phase difference between the two signals to the storage means 5. Then, the storage means 5 changes the timing of outputting the eccentricity correction amount 32 so that the phase difference is removed, thereby modifying the eccentricity correction amount. That is, when the phase difference is large, i.e., when the phase is delayed, the timing of outputting the eccentricity correction amount 32 is made quicker so that the phase difference is reduced. On the other hand, when the phase difference is small, the timing of outputting the eccentricity correction amount 32 is delayed on the contrary. Thereafter, the suspended eccentricity correction is restarted. In this way, by changing the timing of outputting the eccentricity correction amount 32, the relation between eccentricity of the optical disc 1 which is generated due to sliding of the optical disc 1 and eccentricity correction can be restored to a state before the sliding of the optical disc 1 occurs.

FIG. 6 is a timing chart illustrating the timing at which the optical disc apparatus according to the fourth embodiment remeasures eccentricity amount.

Interval A in FIG. 6 indicates an interval in which the eccentricity correction is performed on the basis of the eccentricity amount read from the storage means 5. In these intervals, the output from the amplification means 4 is the result of synthesis of the result of eccentricity correction performed on the basis of the eccentricity correction amount which is outputted from the storage means 5 and amplified by the control amplification circuit 6, and the amount of eccentricity of the optical disc itself which is generated due to deviation of the optical disc 1. The interval B in FIG. 6 indicates a period during which amplitude of the TE signal becomes larger and the eccentricity correction is suspended under commands from the comparator 10. In this period during which the eccentricity correction is suspended, information on actual eccentricity is outputted from the amplification means 4 (amplification means 4 in FIG. 6). The phase difference detection means 31 receives the eccentricity information outputted from the amplification means 4 and the eccentricity amount 33 outputted from the storage means 5 at the same timing as in the interval A, and measures a phase difference C between these two signals. The storage means 5 receives the phase difference C outputted from the phase difference detection means 31, and changes the timing of outputting the eccentricity correction amount 32 by the phase difference C, and the eccentricity correction is restarted. At this time, the timing of outputting the eccentricity amount 33 is also changed by the same period of time.

In the optical disc apparatus, when the TE signal becomes higher due to flaws on the optical disc 1, such as finger printings or scratches, a flaw detection circuit not shown detects these flaws and outputs a flaw detection signal 22. Therefore, when the flaw detection circuit outputs the flaw detection signal 22, a large phase difference detected due to disturbance of the TE signal is judged to be due to flaws, and masking is performed so that the control command 7 on re-storing is not outputted to the storage means 5 even when the above-described condition is satisfied, thereby suppressing unnecessary re-storing in the storage means 5.

As described above, the optical disc apparatus according to the fourth embodiment is provided with the minimum value detection means for detecting the minimum value of the TE signal, and a phase difference detection means for detecting a phase difference between an actual eccentricity amount detected by the eccentricity amount detection means and an eccentricity amount stored in the storage means. Therefore, it is possible to detect sliding of the optical disc more accurately, which is caused by an effect of imperfect attachment of the optical disc, dust or the like, when a rotating rate of the spindle motor is changed or the like, and eccentricity of the optical disc can be corrected without reading an address, data or the like from the optical disc. Further, since the storage means changes the timing of outputting the eccentricity correction amount on the basis of the detected phase difference, the eccentricity of the optical disc can be corrected even without performing remeasurement of eccentricity amount.

In the above-mentioned description, eccentricity of the optical disc 1 is corrected by changing the timing of outputting the eccentricity correction amount 32 from the storage means 5 on the basis of the phase difference detected by the phase difference detection means 31. However, it is also possible that sliding of the optical disc 1 is judged to be generated when the phase difference detected by the phase difference detection means 31 is larger than the reference value, a control means (not shown) outputs the control command 7 to the storage means 5, and the storage means 5 re-stores an eccentricity amount according to the control command 7, whereby sliding of the optical disc can be detected more accurately, and eccentricity of the optical disc can be similarly corrected without reading an address, data or the like from the optical disc.

(Embodiment 5)

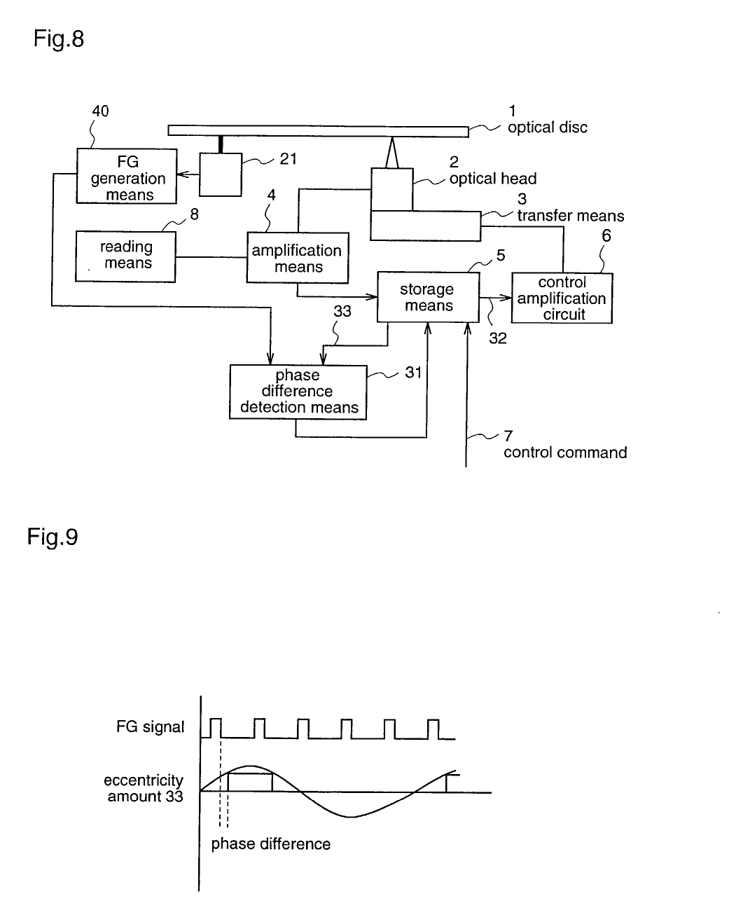

Hereinafter, a fifth embodiment of the present invention will be described with reference to FIGS. 8 and 9.

FIG. 8 is a block diagram illustrating the construction of an optical disc apparatus according to the fifth embodiment.

As shown in FIG. 8, the optical disc apparatus is provided with an FG generation means 40 for outputting a pulse signal according to a rotational position of a spindle motor 21, and a phase difference detection means 31 for detecting a phase difference between an eccentricity amount stored in a storage means 5 and position information generated by the FG generation means. Since other constituents are identical to those described for the first embodiment, their descriptions will be omitted here.

Next, the operation of the so-constructed optical disc apparatus according to the fifth embodiment will be described.

The procedure until focus control and tracking control are performed after the spindle motor 21 rotates is identical to that described for the first embodiment.

Eccentricity correction is performed after the tracking control is started. Hereinafter, the operation for the eccentricity correction will be described in the order of measurement of eccentricity amount, execution of eccentricity correction on the basis of a measurement value, detection of sliding of the optical disc 1 in the rotating direction, correction of the eccentricity amount, and restart of the eccentricity correction.

The operation until the first measurement of eccentricity amount is performed is identical to that described for the first embodiment.

Detection of sliding of the optical disc 1 in the rotating direction is performed as follows. Initially, the phase difference detection means 31 makes a phase comparison between the eccentricity amount 33 outputted from the storage means 5 and information on a rotational position of the spindle motor 21 which is outputted from the FG generation means 40. The phase comparison is made by measuring a time for which the eccentricity amount 33 exceeds a setting value, for each rotation of the optical disc 1 utilizing that the FG generation means 40 outputs a pulse (FG signal) M times for each rotation of the optical disc 1. Then, when the phase difference detected by the phase difference detection means 31 exceeds a prescribed reference value, it is judged that the optical disc 1 has slid.

Correction of eccentricity amount is performed as follows. Initially, the phase difference detection means 31 outputs the detected phase difference to the storage means 5. Then, the storage means 5 changes the timing of outputting the eccentricity correction amount 32 so that the phase difference is removed. That is, when the phase difference is large, i.e., when the phase is delayed, the timing of outputting the eccentricity correction amount 32 is made quicker so that the phase difference is reduced. On the other hand, when the phase difference is small, the timing of outputting the eccentricity correction amount 32 is delayed on the contrary.

In this way, by changing the timing of outputting the eccentricity correction amount 32, the relation between eccentricity of the optical disc 1 which is generated due to sliding of the optical disc 1 and eccentricity correction can be restored to a state before the sliding of the optical disc 1 occurs.

FIG. 9 is a timing chart illustrating a timing at which the optical disc apparatus according to the fifth embodiment detects the phase difference. FIG. 9 shows a timing of detecting the phase difference between the FG signal outputted from the FG generation means 40 and the eccentricity amount 33 outputted from the storage means 5.

As described above, the optical disc apparatus according to the fifth embodiment is provided with the FG generation means for generating the FG signal, and the phase difference detection means for detecting the phase difference between the FG signal and the eccentricity amount outputted from the storage means, and employs the FG signal as a reference signal at the phase comparison, so as to detect a phase difference between an actual eccentricity amount and an eccentricity correction amount without suspending eccentricity correction, thereby detecting sliding of the optical disc 1. Further, this optical disc apparatus can perform the eccentricity correction without requiring reading of an address or data unlike a conventional optical disc apparatus.

In the above-mentioned description, eccentricity of the optical disc 1 is corrected by changing the timing of outputting the eccentricity correction amount 32 from the storage means 5 on the basis of the phase difference detected by the phase difference detection means 31. However, it is also possible that sliding of the optical disc 1 is judged to be generated when the phase difference outputted by the phase difference detection means 31 is larger than the reference value, a control means (not shown) outputs the control command 7 to the storage means 5, and the storage means 5 re-stores an eccentricity amount according to the control command, whereby sliding of the optical disc 1 can be detected more accurately, and eccentricity of the optical disc 1 can be similarly corrected without reading an address, data or the like from the optical disc 1.

(Embodiment 6)

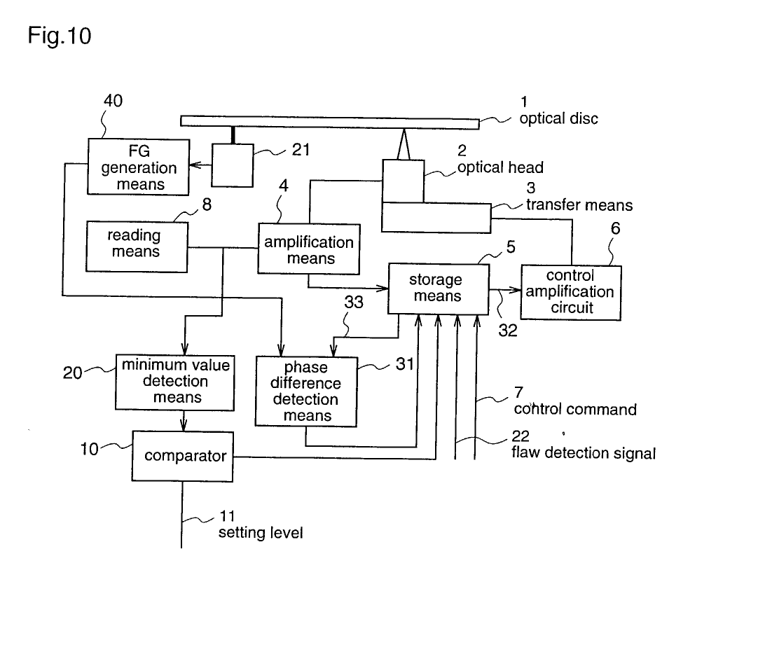

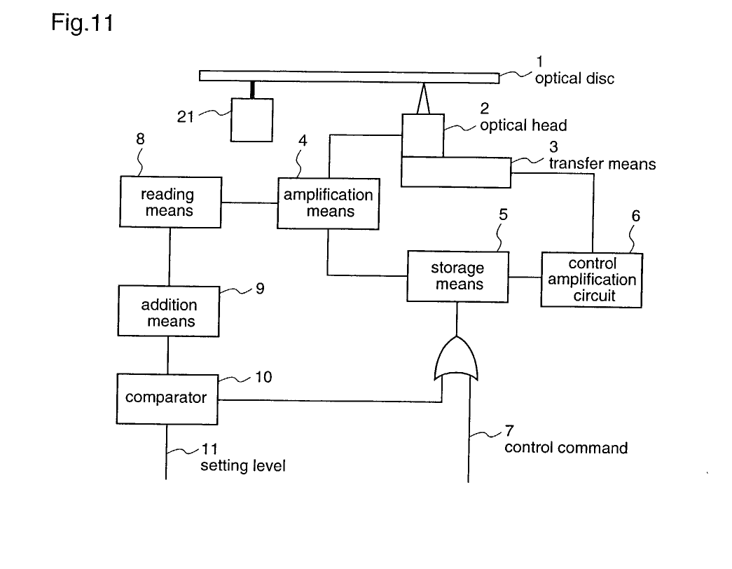

Hereinafter, a sixth embodiment of the present invention will be described with reference to FIGS. 10 and 9.

FIG. 10 is a block diagram illustrating the construction of an optical disc apparatus according to the sixth embodiment.

As shown in FIG. 10, the optical disc apparatus is provided with an FG generation means 40 for outputting a pulse signal according to a rotational position of a spindle motor 21, and a phase difference detection means 31 for detecting a phase difference between the pulse signal and an eccentricity amount outputted from a storage means 5. Since other constituents are identical to those described for the first embodiment, their descriptions will be omitted here.

Next, the operation of the so-constructed optical disc apparatus according to the sixth embodiment will be described.

The procedure until focus control and tracking control are performed after the spindle motor 21 rotates is identical to that described for the first embodiment.

Eccentricity correction is performed after the tracking control is started. Hereinafter, the operation for the eccentricity correction will be described in the order of measurement of eccentricity amount, execution of eccentricity correction on the basis of a measurement value, detection of sliding of the optical disc in the rotating direction, correction of the eccentricity amount, and restart of the eccentricity correction.

The operation until the first measurement of eccentricity amount is performed is identical to that described for the first embodiment.

Detection of sliding of the optical disc 1 in the rotating direction is performed as follows. Initially, the minimum value detection means 20 detects the minimum value of a TE signal which is detected by the amplification means 4, in a predetermined period. Then, the comparator 10 compares the minimum value with the setting level 11, and judges that the optical disc 1 might have slid when the minimum value exceeds the setting level 11.

Next, the phase difference detection means 31 makes a phase comparison between the eccentricity amount 33 outputted from the storage means 5 and information on a rotational position of the spindle motor 21 which is outputted from the FG generation means 40. The phase comparison is made by measuring a time for which the eccentricity amount 33 exceeds a setting value, for each rotation of the optical disc 1 utilizing that the FG generation means 40 outputs a pulse (FG signal) M times for each rotation of the optical disc 1. When the detected phase difference exceeds a prescribed reference value, it is judged that the optical disc 1 might have slid. When both of the comparator 10 and the phase difference detection means 31 judge that the optical disc 1 might have slid, the optical disc 1 is judged to have slid.

Correction of eccentricity amount is performed as follows. Initially, the phase difference detection means 31 outputs the detected phase difference to the storage means 5. Then, the storage means 5 changes the timing of outputting the eccentricity correction amount 32 so that the phase difference is removed. That is, when the phase difference is large, i.e., when the phase is delayed, the timing of outputting the eccentricity correction amount 32 is made quicker so that the phase difference is reduced. On the other hand, when the phase difference is small, the timing of outputting the eccentricity correction amount 32 is delayed on the contrary.

In this way, by changing the timing of outputting the eccentricity correction amount 32, the relation between eccentricity of the optical disc 1 which is generated due to sliding of the optical disc 1 and eccentricity correction can be restored to a state before the sliding of the optical disc 1 occurs.

When the TE signal becomes higher due to flaws on the optical disc 1, such as finger printings or scratches, a flaw detection circuit not shown detects these flaws and outputs a flaw detection signal 22. Therefore, when the flaw detection circuit outputs the flaw detection signal 22, disturbance of the TE signal is judged to be due to flaws, and masking is performed so that the control command 7 on re-storing is not outputted to the storage means 5, thereby suppressing unnecessary remeasurement in the storage means 5.

FIG. 9 is a timing chart illustrating a timing at which the optical disc apparatus according to the sixth embodiment detects the phase difference. FIG. 9 shows a timing of detecting the phase difference between the FG signal outputted from the FG generation means 40 and the eccentricity amount 33 outputted from the storage means 5.

As described above, the optical disc apparatus according to the sixth embodiment is provided with the minimum value detection means for detecting the minimum value of the TE signal, the FG generation means for generating the FG signal, and the phase difference detection means for detecting the phase difference between the FG signal and the eccentricity amount outputted from the storage means, whereby sliding of the optical disc can be detected more accurately and, thus, eccentricity can be corrected more accurately. Further, since the FG signal is employed as a reference signal at the phase comparison, a phase difference between an actual eccentricity amount and an eccentricity correction amount can be detected without suspending the eccentricity correction.

In the above-mentioned description, eccentricity of the optical disc 1 is corrected by changing the timing of outputting the eccentricity correction amount from the storage means 5 on the basis of the phase difference detected by the phase difference detection means 31. However, it is also possible that deviation of the optical disc 1 is judged to be generated when the phase difference as the result of the phase comparison by the phase difference detection means 31 is larger than the reference value, a control means (not shown) outputs the control command 7 to the storage means 5, and the storage means 5 re-stores an eccentricity amount on the basis of the control command 7, whereby sliding of the optical disc 1 can be detected more accurately, and eccentricity of the optical disc 1 can be similarly corrected without reading an address, data or the like from the optical disc 1.

What is claimed is:

1. An optical disc apparatus for recording or reproducing data on/from an optical disc by applying an optical spot on the optical disc with an optical pickup, comprising:
an error signal generation means for generating an error signal for making the optical pickup follow a track on the optical disc;
an eccentricity amount detection means for detecting an eccentricity amount of the optical disc;
a storage means for storing the eccentricity amount detected by the eccentricity amount detection means; and
a control means for performing control so as to correct the eccentricity amount stored in the storage means when the output from the error signal generation means has a value larger than a prescribed setting value.

2. An optical disc apparatus for recording or reproducing data on/from an optical disc by applying an optical spot on the optical disc with an optical pickup, comprising:
an error signal generation means for generating an error signal for making the optical pickup follow a track on the optical disc;
an eccentricity amount detection means for detecting an eccentricity amount of the optical disc;
a storage means for storing the eccentricity amount detected by the eccentricity amount detection means;
a comparison circuit for comparing the eccentricity amount outputted from the storage means with a prescribed reference value; and
a control means for performing control so as to correct the eccentricity amount stored in the storage means when the comparison circuit detects that the eccentricity amount exceeds the prescribed reference value.

3. An optical disc apparatus for recording or reproducing data on/from an optical disc by applying an optical spot on the optical disc with an optical pickup, comprising:
an error signal generation means for generating an error signal for making the optical pickup follow a track on the optical disc;
an eccentricity amount detection means for detecting an eccentricity amount of the optical disc;
a storage means for storing the eccentricity amount detected by the eccentricity amount detection means;
a phase difference detection means for detecting a phase difference between the eccentricity amount outputted from the eccentricity amount detection means and the eccentricity amount outputted from the storage means; and
a control means for performing control so as to correct the eccentricity amount stored in the storage means when the output from the phase difference detection means has a value larger than a prescribed setting value.

4. An optical disc apparatus for recording or reproducing data on/from an optical disc by applying an optical spot on the optical disc with an optical pickup, comprising:
an error signal generation means for generating an error signal for making the optical pickup follow a track on the optical disc;
a rotational position detection means for outputting a signal according to a rotational position of a rotation means that rotates the optical disc;
an eccentricity amount detection means for detecting an eccentricity amount of the optical disc;
a storage means for storing the eccentricity amount detected by the eccentricity amount detection means;
a phase difference detection means for detecting a phase difference between position information outputted from the rotational position detection means and the eccentricity amount outputted from the storage means; and
a control means for performing control so as to correct the eccentricity amount stored in the storage means when the output from the phase difference detection means has a value larger than a prescribed setting value.

5. The optical disc apparatus of claim 3 or 4, wherein
the control means performs control so as to change a timing at which the storage means outputs an eccentricity correction amount, on the basis of the phase difference detected by the phase difference detection means when the output from the phase difference detection means has a value larger than the prescribed setting value.

6. The optical disc apparatus as defined in claim 3 or 4, wherein
the control means performs control so that the storage means re-stores an eccentricity amount of the optical disc when the output from the phase difference detection means has a value larger than the prescribed setting value.

7. The optical disc apparatus of any of claims 2 to 4, wherein
the control means performs control so as to correct the eccentricity amount stored in the storage means only when the output from the error signal generation means has a value larger than the prescribed setting value.

8. The optical disc apparatus of any of claims 1 to 4, further including:
a minimum value detection means for detecting that the minimum value of the output from the error signal generation means exceeds a prescribed value for more than a predetermined period of time, wherein
the control means performs control so as to correct the eccentricity amount stored in the storage means only when the minimum value detection means detects that the minimum value of the output from the error signal generation means exceeds the prescribed value for more than the predetermined period of time.

9. The optical disc apparatus of any of claims 1 to 4, further including:
a flaw detection circuit for detecting flaws on the optical disc, wherein
the control means performs control so as not to correct the eccentricity amount stored in the storage means when the flaw detection circuit detects flaws.
